(19) United States
(12) Patent Application Publication
(10) Pub. No.: US 2014/0001724 A1
(43) Pub. Date: Jan. 2, 2014

(54) FOUR AND FIVE BAR LINKAGE STEERING MECHANISM FOR 3 WHEEL VEHICLE AND METHODS FOR DEFINING THE GEOMETRY OF SAID VAHICLE

(71) Applicant: BEHRANG MEHRGAN, RANCHO SANTA MARGARITA, CA (US)

(72) Inventor: BEHRANG MEHRGAN, RANCHO SANTA MARGARITA, CA (US)

(73) Assignee: BEHRANG MEHRGAN, RANCHO SANTA MARGARITA, CA (US)

(21) Appl. No.: 13/615,392

(22) Filed: Sep. 13, 2012

Related U.S. Application Data
(60) Provisional application No. 61/534,305, filed on Sep. 13, 2011.

(51) Int. Cl. B62D 7/00; A63C 17/01

(52) U.S. Cl. CPC B62D 7/00; A63C 17/013
USPC 280/87.041; 280/62

(57) ABSTRACT

This invention provides a steering mechanism solution for increasing the stability of 3 wheel cars. This invention is suitable for a 3 wheel car, with 2 fixed wheels on one end, and one steerable wheel on the other end. According to this invention, by employing a 4 bar linkage mechanism, which can be upgraded to a 5 linkage mechanism, the steerable wheel position will be shifted in a way to increases the distance between the center of gravity of the car and the tipping line. The stability of a 3 wheel car with this steering mechanism can be compared with a 4 wheel vehicle.

### RELATED US APPLICATION DATA

Provisional Application No.: 61/534,305 Filed on 13 Sep. 2011

U.S. Cl.: 280/92

### FIELD OF SEARCH

270, 274, 275, 180/210, 211, 215, 216

### REFERENCES CITED

U.S. Pat. No. 4,546,997 Oct. 15, 1985 Eugene D. Smyer

U.S. Pat. No. 5,568,935 Oct. 29, 1996 Williams P. Mason

U.S. Pat. No. 7,543,829 Aug. 7, 2006 Danny Barnes

U.S. Pat. No. 7,850,180 Dec. 14, 2010 Joseph Wilcox

U.S. Pat. No. 2,038,843 Apr. 28, 1936 Joseph R. Jones

U.S. Pat. No. 4,353,567 Oct. 12, 1982 Ross A. Weldy

U.S. Pat. No. 1,623,726 Apr. 5, 1927 EDVIN HERDS, EDVIN HERDS

### BACKGROUND OF THE INVENTION

1. Field of Invention

This invention is in the field of the steering systems for 3 wheel cars.

2. Description of the Related Art

Three wheel cars are believed to have a more important role in the future of the auto industry. They can be lighter, have a simpler chassis, and can have better fuel economy. The main disadvantage of these cars is poor stability. Despite producing many concept 3 wheel cars, up to this moment no large car manufacturer has ever started mass production of 3 wheelers mainly because of stability and safety concerns. The main reason for the poor stability is that the center of gravity of the 3 wheel cars, is very close to the tipping line of the cars.

There are many solutions provided by different inventers, for example tilting the 3 wheeler car when steering, similar to tilting motorcycles at the race corners. This solution slightly moves the center of gravity far from the tipping line, and then helps for better stability. But tilting solution is not normally economically feasible and is not applicable for bigger 3 wheelers.

Patents U.S. Pat. No. 45,469,97 dated Oct. 15, 1985 filed by Eugene D. Smyer, U.S. Pat. No. 5,568,935 dated Oct. 29, 1996 filed by Williams P. Mason, U.S. Pat. No. 7,543,829 dated Aug. 7, 2006 filed by Danny Barnes, U.S. Pat. No. 7,850,180 dated Dec. 14, 2010 filed by Joseph Wilcox have employed different tilting mechanism. The current invention provides tilting too, but without using any kind of tilting mechanism. The tilting will be done due to the change in the weight distribution of the vehicle.

U.S. Pat. No. 4,353,567 Dated Oct. 12, 1982 filed by Ross A. Weldy has used nearly the same solution of this invention but is missing the fifth linkage. Also the mechanism is only suggested for a front wheel driven 3 wheel cars. The problem is that the friction forces applied to the front wheel from the road, intend to move the wheel away from the neutral position. So the vehicle will not drive in a straight line if the driver does not keep the steering wheel in hands.

Since the current invention is very similar to the above mentioned invention, it has the same disadvantage for the front steering and it is mainly suggested for the rear steered 3 wheelers, where there are 2 rigid wheels on front, and one steerable on the rear. In case the rear steer solution the friction forces applied to the wheel intend to bring the wheel to the neutral position. So the drive is stable. It is possible to use this invention for the front wheel by employing a centering mechanism, or a non-feedback power steering.

Another disadvantage of the stated invention is that all the weight of the front of the vehicle will be applied on the 2 rocker linkages. According to the current invention, a 5^{th} linkage will handle all the weights which will highly increase the service life of the pivot joints.

U.S. Pat. No. 2,038,843 dated Apr. 28, 1936 file by Joseph R. Jones, provides a solution for a 3 wheeler with 2 front wheels, and one rear wheel, which by use of a pivot joint, can move the steerable rear wheel away from the center of gravity when steering, and then the distance between tipping line and the center of gravity will be increased and consequently, the stability can be improved. The main problem of this solution is that the wheel intends to move as far as possible from the neutral position in straights due to the friction forces applied from the road to the wheel. So the vehicle drive is not stable.

The current invention provides a different mechanical solution, which steers nearly the same. But when having the mechanism on rear, both friction and centrifugal forces, intend to return the wheel to the neutral position. Then the vehicle can be completely under control.

U.S. Pat. No. 1,623,726 dated Apr. 5, 1927 published by EDVIN HERDS, EDVIN HERDS US Cl. 280/92 offers exactly the same solution of the previous mentioned patent (2038843) but for the front. In this case, the friction forces help to return the wheel to the neutral position, and so the invention can practically be used. But obviously it is different from the current invention.

### BRIEF SUMMERY OF THE INVENTION

The invented steering system is based on a double rocker 4 bar mechanism, which is a well known 4 bar mechanism. The fixed link is the vehicle chassis, or is connected to the chassis by a rigid connection or a pivot joint parallel or concentric to its axis, the rocker linkages have equal lengths, and coupler is smaller than the fixed linkage, and the wheel is connected to the coupler at any point in a way that the direction of the movement of the wheel is perpendicular to the coupler.

The suggested steering mechanism is mainly invented for a 3 wheel vehicle with 2 rigid wheels in front, and one steerable wheel in the rear. But it can also be used for a front steer 3 wheeler.

As it will be shown later, a 5^{th} bar can be connected between the coupler and the chassis, to carry all the weight applied on the wheel. By using this bar, the load on the joints will considerablly be reduced.

The main advantage of this invention is that when the vehicle is making a turn, the tipping line which is the line connecting the outer track of the front and rear wheels with the bigger turning radius, will be shifted away from the center of the gravity of the vehicle, which consequently increases the vehicle's stability at turns.

Another object of this invention is to obtain the dimension of the middle and rear part of the body for the rear steer 3 wheel car, in a way that the rear side of the car does not hit an obstacle that the front of vehicle has passed.

Also since rotating the steering wheel when the vehicle is stopped moves the vehicle end, the vehicle is likely to touch an object which is located at its sides, for example a car in traffic. A solution is suggested which helps to keep the total sum of the vehicle width at each point plus total displacement of both sides equal to maximum width of the vehicle. This way no part of the vehicle may go out of the vehicle's lane when rotating the steering wheel.

Another benefit of this invention is that by change of the position of the steerable wheel, the weight distribution changes. Technically the vehicle will have 2 wheels at one side and one wheel at the other side. So the vehicle will be tilted to the side which has only one wheel, and this situation also helps for the better stability.

A main advantage of this invention is that the vehicle axis is always tangent to the driving path, even when making sharp turns. It provides better stability. The lights cover more useful area when making turns, and also the drag coefficient is the same when making turns and driving in straights.

### BRIEF DESCRIPTION OF THE SEVERAL VIEW OF THE DRAWINGS

FIG. 1. General layout of a 3 wheel vehicle with 4 bar steering mechanism

FIG. 2. The 4 bar steering mechanism in 3 different positions

FIG. 3. This figure shows how the said mechanism improves stability by shifting the tipping line away from the center of gravity

FIG. 4. Movement of vehicle body in case of rotating the steering wheel when the vehicle is stopped

FIG. 5. Method for defining the 3 position center of gravity of the middle point of the coupler linkage

FIG. 6. Four bar mechanism plus the fifth bar

FIG. 7. Steering system with two 4 bar mechanism and one assisting bar

FIG. 8. Isometric view of steering system with two 4 bar mechanism and one assisting bar and suspension connected to the coupler linkage

FIG. 9. Side view of steering system with two 4 bar mechanism and one assisting bar and suspension connected to the coupler linkage

FIG. 10. Isometric view of steering system with 4 bar mechanism and suspension connected to the coupler linkage in neutral position.

FIG. 11. Isometric view of steering system with 4 bar mechanism and suspension connected to the coupler linkage in neutral position.

FIG. 12. Side view of steering system with 4 bar mechanism and suspension connected to the coupler linkage in neutral position.

FIG. 13. Top view of steering system with 4 bar mechanism and suspension connected to the coupler linkage in neutral position.

FIG. 14. Isometric view of steering system with 4 bar mechanism and suspension connected to the coupler linkage.

FIG. 15. Isometric view of steering system with 4 bar mechanism and the spring and damper assembly replaced the assisting linkage in neutral position.

FIG. 16. Isometric view of steering system with 4 bar mechanism and the spring and damper assembly replaced the assisting linkage in neutral position.

FIG. 17. Top view of steering system with 4 bar mechanism and the spring and damper assembly replaced the assisting linkage in neutral position.

FIG. 18. Side view of steering system with 4 bar mechanism and the spring and damper assembly replaced the assisting linkage in neutral position.

FIG. 19. Side view of tilted steering system with 4 bar mechanism and the spring and damper assembly replaced the assisting linkage in neutral position.

FIG. 20. Top view of tilted steering system with 4 bar mechanism and the spring and damper assembly replaced the assisting linkage in neutral position.

FIG. 21. Isometric view of steering system with 4 bar mechanism and spring and damper assembly connected to the fixed linkage of the 4 bar mechanism, in neutral position.

FIG. 22. Steering system with one 4 bar mechanism and one assisting bar and the fixed bar connected to the chassis by a pivot joint.

FIG. 23. A three wheel vehicle with a rear steerable wheel with the right geometry so that the rear wheel track is inside the front wheel track and the rear of the car path passes through the path of the point with maximum width, so that if the front of the car passes an obstacle, the rear of the car or the wheel will not collide with it.

### DETAILED DESCRIPTION OF THE INVENTION

FIG. 1. Shows the simplified 4 bar mechanism of this vehicle. There are 2 free rigid wheels 1, and then there is the steerable wheel 2, which is connected to the chassis by a double rocker four bar linkage mechanism. The wheel is connected to the coupler linkage 5, and then the equal length rocker linkages 3 and 4 connect the linkage 5 to the chassis. The coupler linkage 5 can be of a flat shaped or a U shaped part. The connection of the wheel to the coupler link 5 can be at any point and any side according to the construction of the vehicle. The axis of the wheel 2 can be either concentric with the linkage, under it, or at either sides. But the direction of the movement of the wheel 2 should be perpendicular to the coupler 5.

Every kind of brake system used on motor vehicles can be used for the steerable wheel. In order to make the drawings simpler, no brake or power transmission system is shown on the drawings. In any case for a rear steered vehicle, the force applied from ground to the wheel and steering mechanism at the time of braking intends to bring the steering system to the neutral position. Also acceleration force applied by the wheel to the ground intends to move the steering system away from the neutral position. The forces act opposite in case of a front steered vehicle. So installation of brake and power transmission on the wheel requires a strong enough power steering system, or a power steering system with no feedback from wheels for safety reasons.

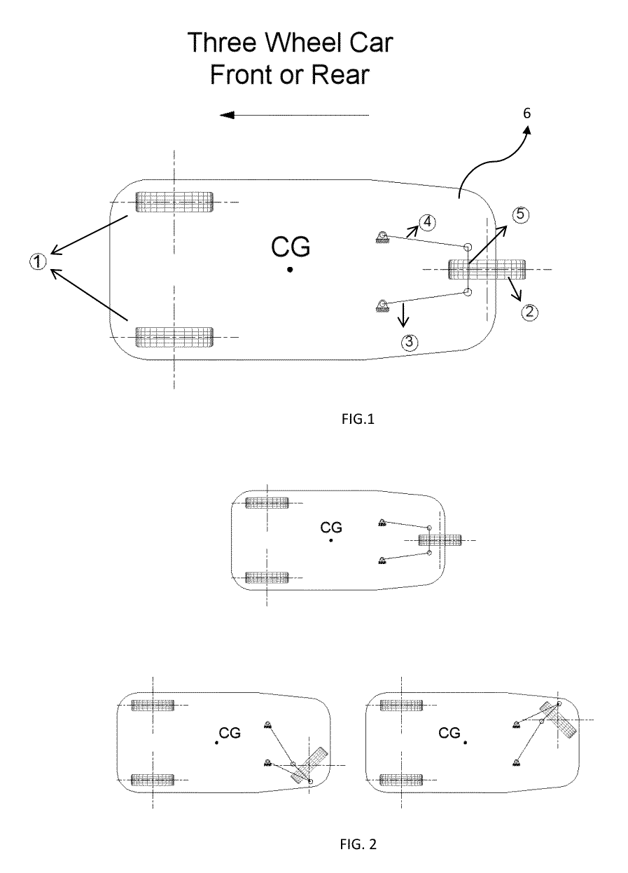

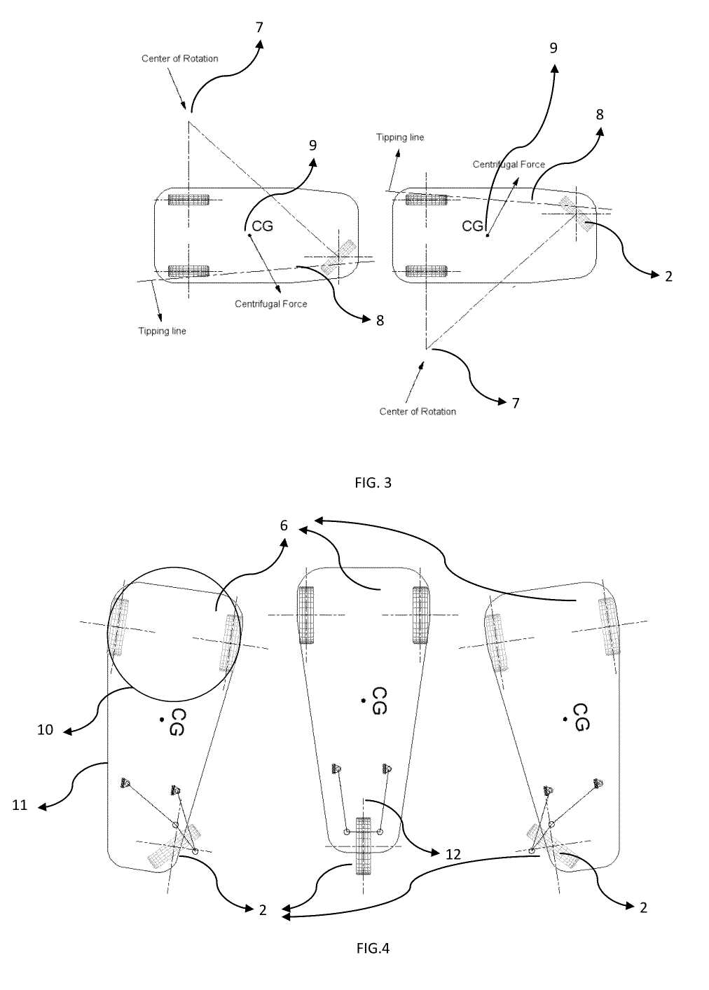

FIG. 2 shows the position of the rigid wheels 1 and the steerable wheel 2 when turning to both sides. FIG. 3, Shows the center of rotation 7, the position of the tipping line 8 relative to the center of gravity 9, and as can be clearly seen, the distance of the center of gravity from the tipping line is comparable with the one of a 4 wheel vehicle.

Another benefit of this invention is that by change of the position of the steerable wheel, the weight distribution changes. Technically the vehicle will have 2 wheels at one side and one wheel at the other side. So the vehicle will be tilted to the side which has only one wheel, and this situation also helps for the better stability.

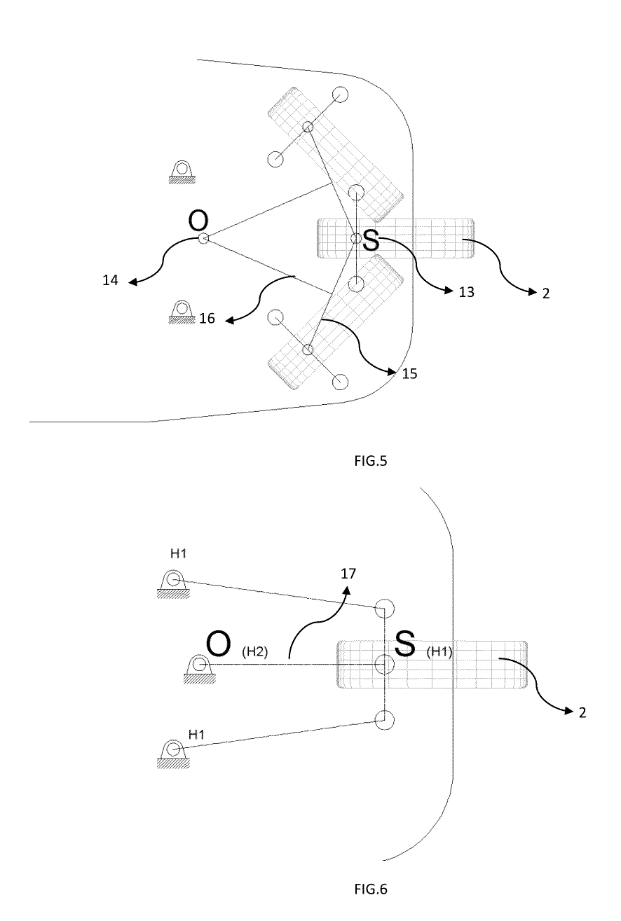

It should be considered that since the steerable wheel 2 is on the ground, rotation of the steering mechanism when the vehicle is stopped, instead of moving the steerable wheel 2, actually moves the body of the vehicle 6, relative to the position of the wheel 2. FIG. 4 shows the outcome. This movement can be dangerous. Especially because the body of the car may touch an obstacle which is laid by its side, or a car in traffic. The solution to obtain the best dimensions to avoid this problem is described here:

The part of the vehicle which has the maximum weight is at the car end with 2 rigid wheels, and is at the axis of the wheels. The outer shape of the body at this point is part of a circle 10 which it center is located at the middle of the centerline of the rigid wheels 1. This way by turning the vehicle at either sides, the maximum width remains unchanged. When the end is moved to each side, a line 11 parallel to the neutral direction 12 of the steerable wheel 2 and tangent to the circle 10 is drawn. This line 12 limits the vehicle dimensions. As long as the body size does not pass this line, no body part will go out of the car lane, in case of rotating the steering wheel when the car is stopped.

Combination of the above 4 bar linkage with spring/damper mechanism is easily possible, and a few solutions are shown here. Before showing the solutions, a new linkage is derived by linkage design techniques, to carry the weight of the vehicle.

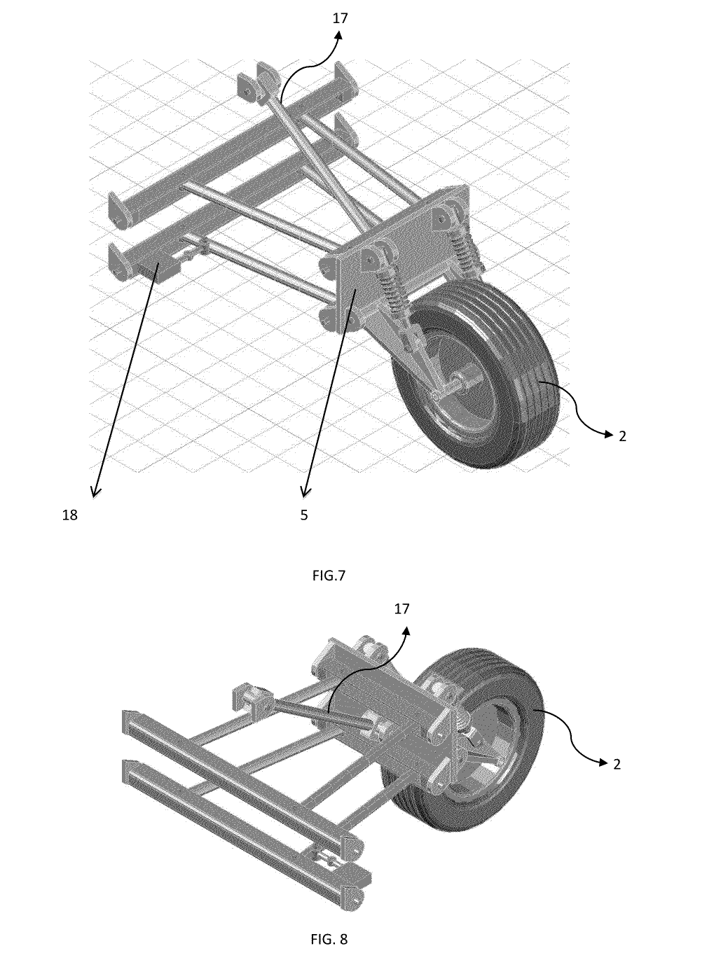

As shown on FIG. 5 and FIG. 6, the 3 position center of rotation Point of point “S” 13, can be found which is named point “O” 14. The position of point S 13, the middle point of the coupler linkage 5 is connected to each other at 3 positions, by connecting lines 15. By connecting 2 perpendicular lines 16 to the middle of the connecting lines 15, the center of rotation point 13 can be derived at the intersection of the middle perpendicular lines 16.

It should be considered that there is no absolute center of rotation available for point 13. But point 14 can be considered as about the center of rotation for the middle point of the linkage 5. The distance between Point “O” 14 and the middle point of linkage 5, which is named Point “S” 13, is nearly fixed, in a full 90 degrees rotation of the wheel, considering the linkages 3 and 4 to be 67 cm, the distance between “O” 14 and “S” 13 only varies less than 2 millimeters. So by choosing these points on different heights, and connecting these points by the 5^{th} bar 17 as shown on FIG. 6 and FIG. 7, the nearly horizontal movement of the 4 bar mechanism is guaranteed. The center of rotation point 14 can be chosen either at a higher, or a lower height than the point S. Linkage 17 should be connected at both sides by a ball joint or combination of a few joints to provide the required degree of freedom. The linkage 17 should be connected to the chassis at point “O” 14.

There are different solutions for the suspension placement.

Solution 1—suspension on linkage 5

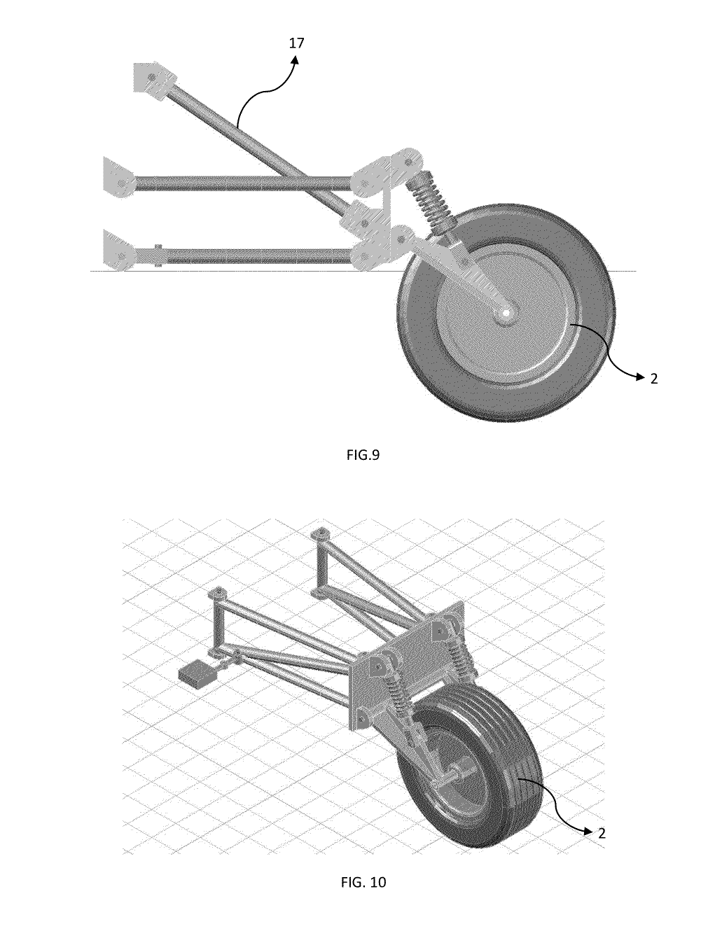

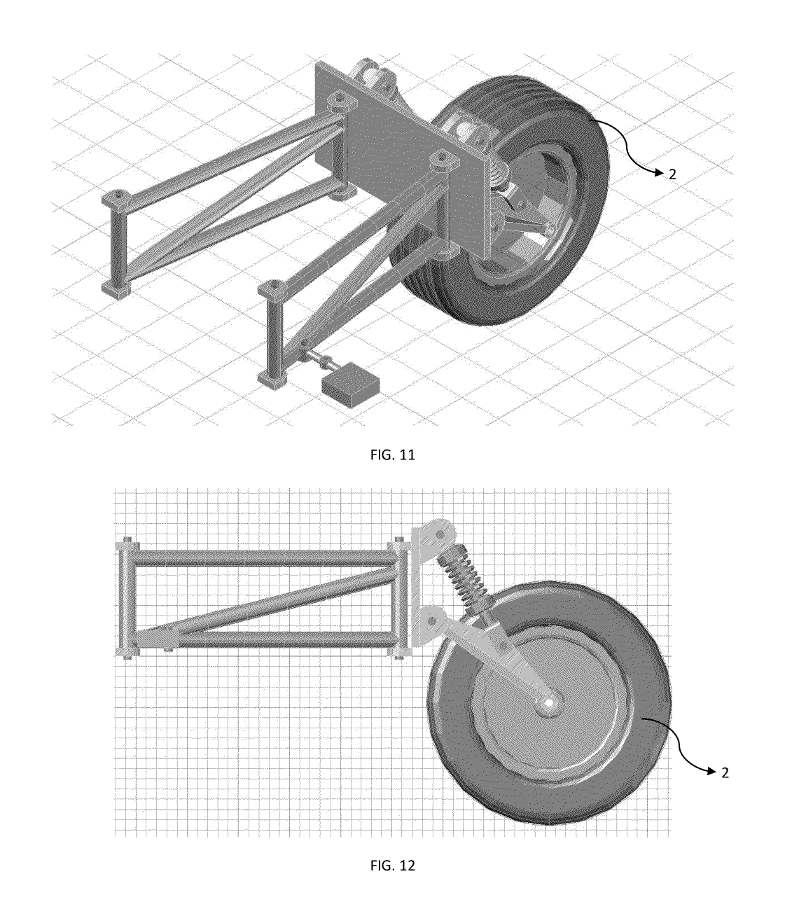

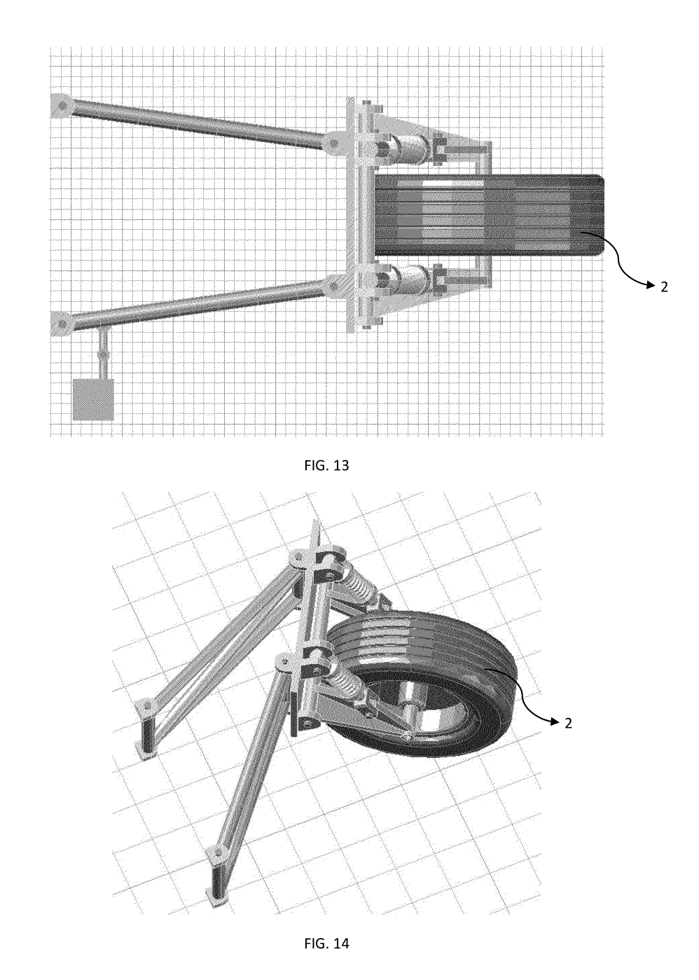

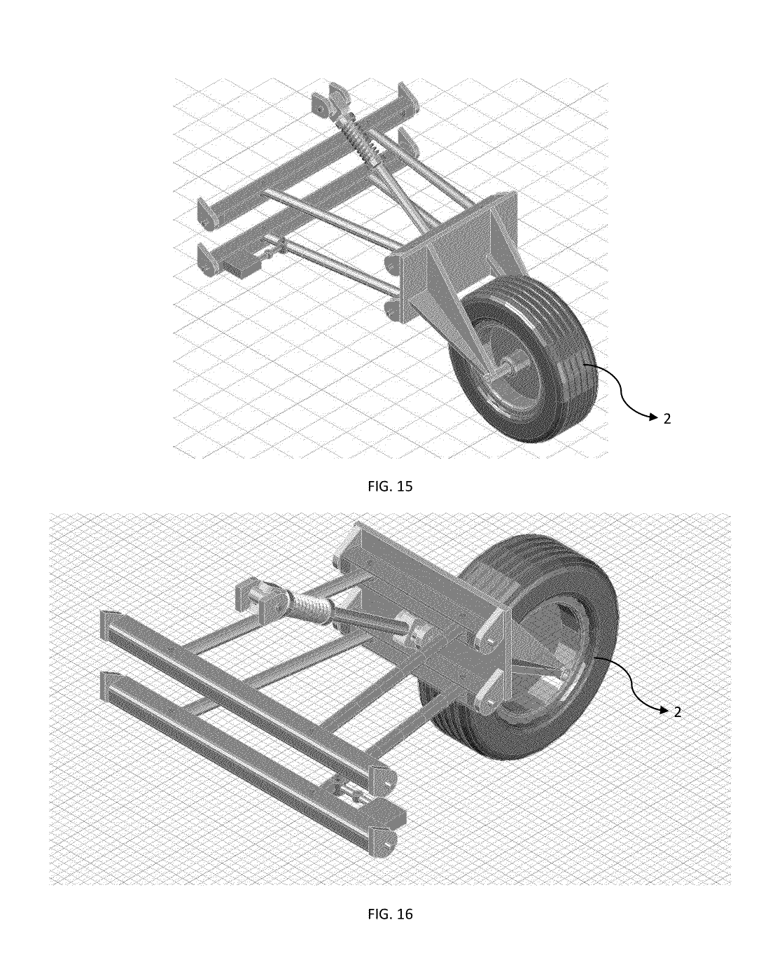

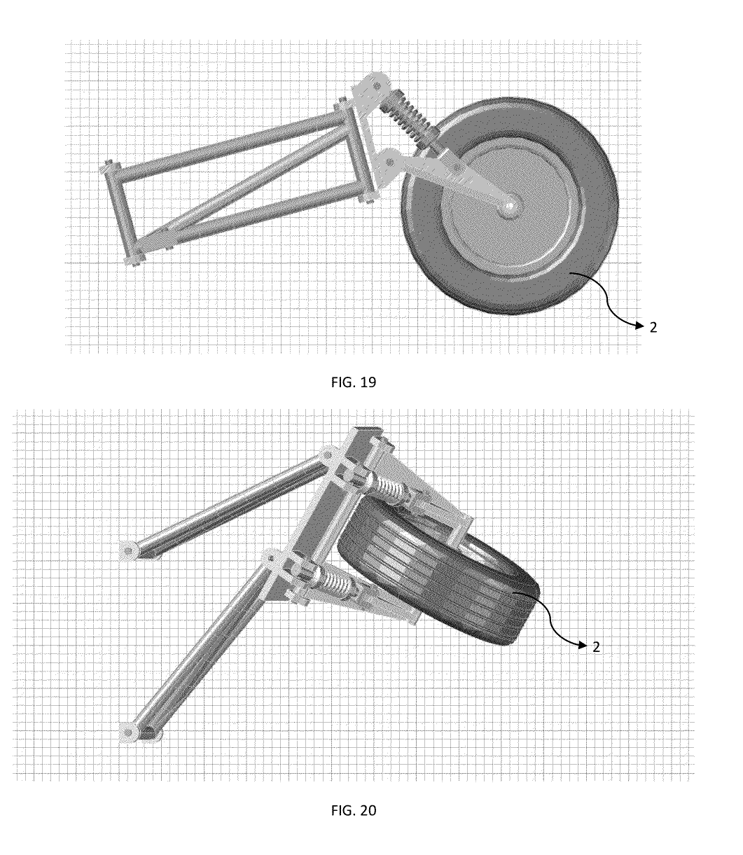

A few examples are shown in FIG. 7, FIG. 8, FIG. 9, FIG. 10, FIG. 11, FIG. 12, FIG. 13, FIG. 14, FIG. 19, FIG. 20, FIG. 22. Technically kind of conventional suspension can be connected to the linkage 5. Design of the suspension system to be connected to the linkage 5 is not an object of this invention.

Solution 2—Spring and damper to replace Linkage 17.

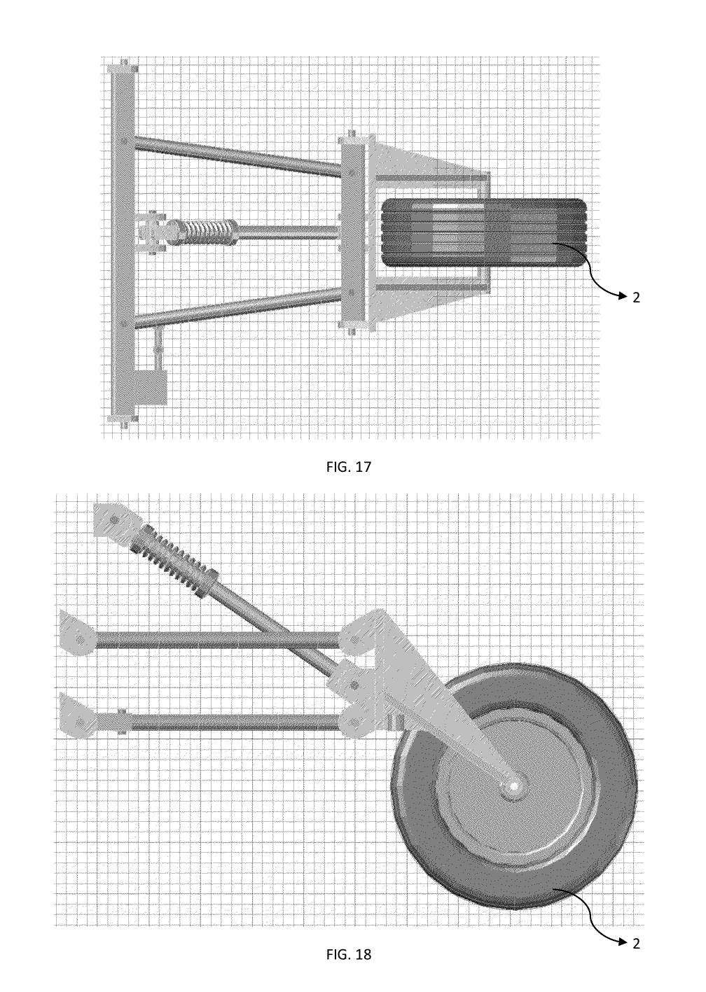

A few examples are shown in FIG. 15, FIG. 16, FIG. 17, FIG. 18.

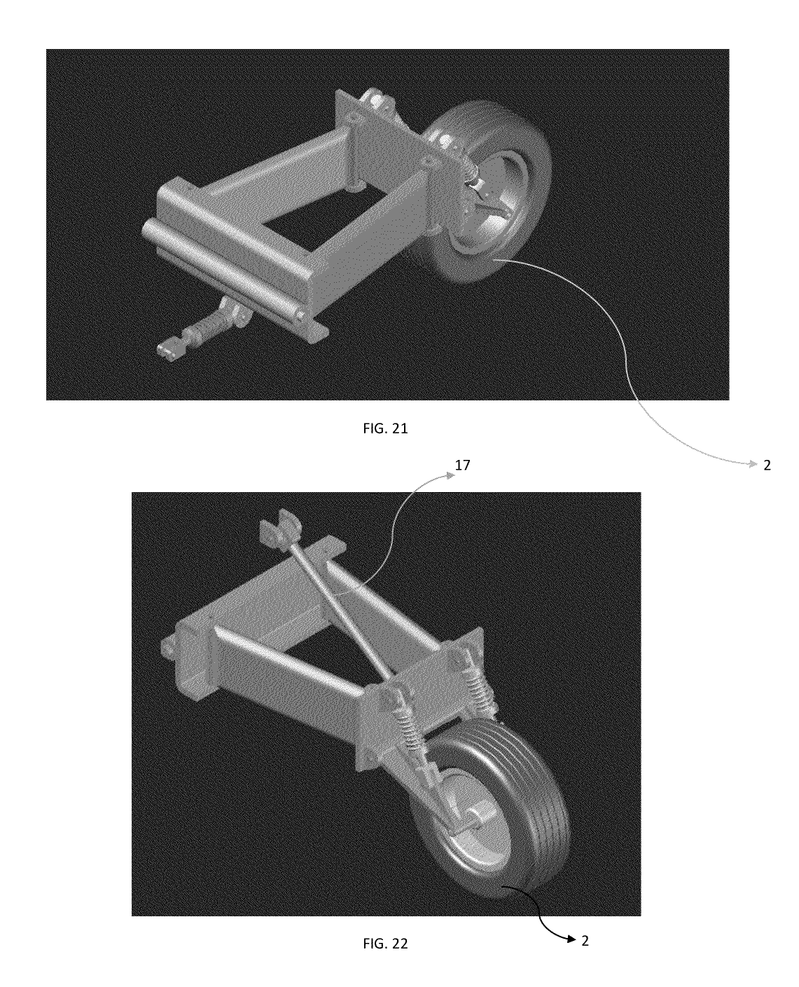

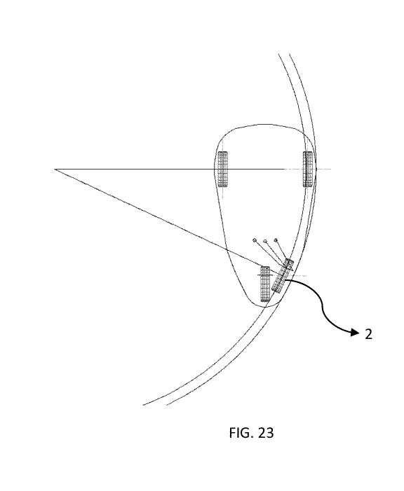

FIG. 12, FIG. 13, and FIG. 21 show a solution without the assisting linkage 17. This solution is the same as solution 1, but the 5^{th} linkage bar is excluded and the other linkages have rigid structure and pivot joints. This solution will be heavier since linkages should be much stronger

For all the above mentioned solutions, the whole mechanism, can be tilted as shown in FIG. 19. And FIG. 20. The effect is that when steered, the steerable wheel will also be tilted like the motorcycles when they pass the corners in motor racing. FIG. 20 shows the effect from top view. Obviously the wheel is tilted as the side of it can be clearly seen. This effects shifts the wheel track even more away from the center of gravity.

1. A Steering mechanism for a three wheel vehicle, whereas the vehicle has 2 rigid non steered wheels on front or rear, and one steerable wheel at the other side, and the steering mechanism is based on a double rocker 4 bar mechanism, whereas the fixed link is the vehicle chassis, or is connected to the chassis by a rigid connection or a pivot joint parallel or concentric to its axis, the rockers have equal lengths, and coupler is smaller than the fixed linkage, and the wheel is connected to the coupler at any point in a way that the direction of the movement of the wheel is perpendicular to the coupler.

2. Three wheel vehicle subject of claim 1 whereas the fixed bar is connected to the chassis by a joint connection concentric to its axis, and there is a 5^{th} bar, connecting a point on the coupler, to its 3 position center of rotation in a different height in order to carry the weight of the vehicle.

3. Three wheel vehicle subject of claim 1 whereas the steering mechanism has two sets of four bar mechanism in parallel.

4. Three wheel vehicle subject of the claim 1 whereas the three wheel vehicle is a scooter

5. Three wheel vehicle subject of the claim 1 whereas the three wheel vehicle is a skateboard

6. Vehicle subject of the claim 1, whereas the steerable wheel, is consisted of multiple co-axial wheels.

7. Vehicle subject of claim 1, whereas the vehicle end with 2 rigid wheels has the maximum width, and angles of the side walls of the vehicle are decided in a way, that the total sum of the vehicle width at each point and lateral movements of the body to the both sides due to the turning the steering wheel, does exceed the vehicles maximum width, which means if the vehicle is stopped in a narrow tunnel nearly as narrow as the vehicle's width, the sides of the vehicle will not collide with the walls if the driver turns the steering wheel without moving the vehicle.

8. method for claim 8 where as the wider part of the vehicle is part of a circle that its center is located in the middle of the centerline of the rigid wheels, so that the maximum width does not change when the vehicle rotates for a few degrees, a line parallel to the axis of the wheel in neutral position and tangent to the circle at the inner side of the turn limits the size of the vehicle.

9. vehicle subject of claim 1 with rear steerable wheel whereas the steering mechanism is designed in a way that in forward motion, the path of the rear wheel does not pass out of the front wheel track at minimum turning radius.

10. Vehicle subject of claim 9 whereas the front part of the vehicle has the maximum width, and the geometry of the middle and the rear parts of the said vehicle is decided in a way, that at minimum turning radius, path of no point on the sides of the vehicle, passes out of the path of the maximum width point of the front of the vehicle, which means at any turning radius, when the front part of the vehicle, passes an obstacle, the middle or rear part of the vehicle cannot collide with it.

11. Method for claim 10 whereas a circle is drawn with its center at the center of rotation of the vehicle, and tangent to the point with maximum width at the front of the vehicle, so that the extension of the circle limits the dimension of the rear part of the vehicle.

12. Steering mechanism subject of claim 1 whereas the wheel is connected to the coupler bar by any type of conventional suspension.

13. Steering mechanism subject of claim 2 whereas the wheel is connected to the coupler bar by any type of conventional suspension.

14. Steering mechanism subject of claim 2 whereas 5^{th} bar is replaced by a spring and damper assembly.

15. Steering mechanism subject of claim 1 whereas the fixed linkage of the 4 bar mechanism is connected to the chassis by a pivot joint with concentric or parallel axis with the fixed linkage and shock absorption is provided by connecting the spring and damper assembly in a way to limit the rotation of the whole steering mechanism over the said pivot joint.

16. Steering mechanism subject of claim 1, whereas the whole mechanism is tilted to the chassis side, in order to provide increased shift of the wheel when steered.
